(19) United States
(12) Patent Application Publication
(10) Pub. No.: US 2016/0296074 A1
(43) Pub. Date: Oct. 13, 2016

(54) FOOD COMMINUTING DEVICE

(71) Applicant: Genius GmbH, Limburg (DE)

(72) Inventor: Cedomir REPAC, Brechen (DE)

(73) Assignee: Genius GmbH, Limburg (DE)

(21) Appl. No.: 15/033,466

(22) PCT Filed: Feb. 20, 2015
(86) PCT No.: PCT/EP2015/053575

§ 371 Date: Apr. 29, 2016

(30) Foreign Application Priority Data
Mar. 7, 2014 (DE) 10 2014 204 262.3

(51) Int. Cl. A47J 43/07

(52) U.S. Cl. CPC A47J 43/0777

(57) ABSTRACT

The invention relates to a device for the comminution of foodstuffs having a macerator which is couplable with a drive unit and with a receiving container. Over and above this, the device for the comminution of foodstuffs comprises a movable coupling means which, when the receiving container is coupled with the macerator, is situated in a first position and when it is uncoupled is situated in a second position.

### CROSS-REFERENCE TO RELATED APPLICATIONS

The present application is the U.S. national phase of International Application No. PCT/EP2015/053575 filed Feb. 20, 2015, which claims priority of German Application No. 10 2014 204 262.3 filed Mar. 7, 2014, the entirety of which is incorporated herein by reference.

### FIELD OF THE INVENTION

The invention relates to a device for the comminution of foodstuffs having a macerator which is couplable with a drive unit and with a receiving container.

### BACKGROUND OF THE INVENTION

Known from the prior art is a plurality of variously realized devices for the comminution of foodstuffs which comprise a receiving container for receiving foodstuffs, a device for the comminution of foodstuffs which has cutting means for comminuting foodstuffs, and a drive unit for driving the device for the comminution of foodstuffs. The device for the comminution of foodstuffs extends through an opening in a receiving container bottom and can be coupled with the drive unit at the end projecting out of the receiving container bottom. The receiving container is closed with a cover that is separate from the device for the comminution of foodstuffs.

In addition, also known are devices for the comminution of foodstuffs where an opening is not provided in the receiving container bottom for the device for the comminution of foodstuffs, but rather the device for the comminution of foodstuffs also functions as a closure for the container opening of the receiving container along with its comminution function. Once the receiving container has been filled with foodstuffs, it is closed by means of the device for the comminution of foodstuffs and the device for the comminution of foodstuffs is coupled with the drive unit. To couple the device for the comminution of foodstuffs with the drive unit the device for the comminution of foodstuffs is placed onto the drive unit. This means that with the device for the comminution of foodstuffs placed on the drive unit, the device for the comminution of foodstuffs functions as the bottom of the receiving container and prevents the foodstuffs situated in the receiving container from escaping.

The foodstuffs situated in the receiving container are comminuted when a force which is directed to the drive unit is exerted onto the receiving container and onto the device for the comminution of foodstuffs. In said case, projections which are provided on the receiving container are pressed against switching elements of the drive unit, as a result of which the switching elements are switched over into an On position in which the drive unit is activated. The activated drive unit drives the cutting means such that the foodstuffs situated in the receiving container are comminuted.

A disadvantage of the last of the two previously discussed known apparatuses for the comminution of foodstuffs is that only receiving containers which comprise the identical outside diameter on the side facing the device for the comminution of foodstuffs are able to be used. This is as, otherwise, the projections which are mounted on the receiving containers cannot move into contact with the switching elements which are provided on the drive unit and consequently the drive unit cannot be activated. Consequently, the scope of use of the apparatus for the comminution of foodstuffs is restricted to a small number of forms of receiving containers.

### SUMMARY OF THE INVENTION

The object of the invention is consequently to provide a device for the comminution of foodstuffs in which variously realized receiving containers are able to be used.

Said object is achieved by a device for the comminution of foodstuffs of the type named in the introduction which is characterized in that the device for the comminution of foodstuffs comprises at least one movable coupling means which is mounted on the macerator, wherein when the receiving container is coupled with the macerator the coupling means is situated in a first position and when it is uncoupled it is situated in a second position.

As a result of mounting the movable coupling means on the macerator, a plurality of variously realized receiving containers can be coupled with the device for the comminution of foodstuffs. In particular, the use is not restricted to receiving containers which comprise a certain outside diameter on the side facing the device for the comminution of foodstuffs. As a result, the device for the comminution of foodstuffs functions as an adapter for coupling variously realized receiving containers with the drive unit.

The coupling means can be moved relative to the macerator. When the drive unit is operating, the macerator can be arranged in a stationary manner, in particular in a receiving means of the drive unit. The device for the comminution of foodstuffs can be coupled directly with the receiving container and/or with the drive unit. When operating, the drive unit is placed on the ground. The device for the comminution of foodstuffs can be arranged above a drive motor of the drive unit when viewed along a center axis of the device for the comminution of foodstuffs. The receiving container can be arranged above the device for the comminution of foodstuffs when viewed along the center axis of the device for the comminution of foodstuffs. The receiving container, the drive unit and the device for the comminution of foodstuffs can be arranged in such a manner that the center axes thereof extend coaxially with respect to one another.

As a result of realizing the coupling means in such a manner that it is able to assume at least two positions, it is possible to assign different operating states of the drive unit to different positions of the coupling means. Thus, the first position of the coupling means can correspond to a drive triggering position in which driving a cutting unit of the device for the comminution of foodstuffs by means of the drive unit is possible. As an alternative to this or in addition to it, the second position of the coupling means can correspond to a safety position in which driving a cutting unit of the device for the comminution of foodstuffs by means of the drive unit is not possible.

The provision of a drive triggering position of the coupling means makes it possible to be able to use the device for the comminution of foodstuffs to activate the drive unit, in contrast to the known devices for the comminution of foodstuffs where the drive unit is activated by the receiving container. The provision of the safety position provides the advantage of the device for the comminution of foodstuffs itself ensuring that a user of the device for the comminution of foodstuffs is not able to injure himself if said device is used incorrectly.

In particular, activating the drive unit and consequently the user being injured by the cutting unit of the device for the comminution of foodstuffs is not possible when the device for the comminution of foodstuffs is inserted into the receiving means of the drive unit and is not coupled with the receiving container. This means that when the coupling means is provided in the safety position it is impossible for the drive unit to be able to be activated when the device for the comminution of foodstuffs is coupled with the drive unit.

In a preferred realization, the coupling means can be mounted on the macerator so as to be rotatable, in particular by means of a joint. As an alternative to this, the coupling means can be connected to the macerator in such a manner that the coupling means moves in a linear manner relative to the macerator.

The macerator can be realized in a cup-shaped manner. In particular, the macerator can comprise a macerator wall which is realized with an axially normal cross section, in particular ring-shaped, and a macerator bottom. The macerator wall defines a macerator gap which can serve as a receiving means for the receiving container. In this case, the macerator, in particular the macerator wall, comprises an outside surface and an inside surface, the inside surface being arranged closer to a center axis of the macerator than the outside surface. At least one opening, in which the coupling means is arranged at least in part, is provided in the macerator wall.

The coupling means can stand out from the inside surface of the macerator, in particular radially, in the second position. In particular, the coupling means can stand out from the inside surface inwardly, that is to say in the direction of the center axis of the macerator. The coupling means protruding from the inside surface ensures in a simple manner that when the receiving container is introduced into the macerator, in particular into the macerator gap which is defined by the macerator wall, the receiving container moves into contact, in particular direct contact, with the coupling element.

When coupling with the macerator, in particular when inserting the receiving container into the macerator, the receiving container can move into contact, in particular direct contact, with a first coupling portion of the coupling means. The first coupling portion of the coupling means can be realized in an oblique manner with reference to the direction of the insertion movement of the receiving container and/or to the extension of the center axis of the macerator.

When being inserted into the macerator, the receiving container, in particular a projection protruding from the receiving container, can move into contact with the first coupling portion and exert a force onto said first coupling portion in such a manner that the coupling element moves, in particular in a radial direction. As a result, on the one hand a movement of the coupling means is realized in a simple manner, on the other hand the inserting of the receiving container into the macerator is guided by the obliquely realized coupling portion.

The coupling means can stand out from the outside surface of the body in the first position. In particular, the coupling means can extend radially outward, that is to say proceeding from the outside surface of the macerator in a direction away from the center axis of the macerator. The coupling means protruding from the outside surface of the macerator ensures that a switching element of the drive unit is able to be contacted by the coupling element when the device for the comminution of foodstuffs is coupled with the drive unit. It is the first position or the drive triggering position of the coupling means that consequently makes it possible for the drive unit to be activated by the device for the comminution of foodstuffs.

The coupling means can consist of a different material to the macerator. In particular, the coupling means can consist of a material which comprises a higher breaking strength than the material of the macerator. Providing a break-proof material for the coupling means reduces the risk of it breaking when the coupling means is pressed against the switching element of the drive unit.

The device for the comminution of foodstuffs can be comprise a tensioning means which is connected to the coupling means. Once the receiving container has been uncoupled from the macerator, the tensioning means, in particular a spring, can bring about a return movement of the coupling means from the first position into the second position. Providing the tensioning means ensures in a simple manner that, with the device for the comminution of foodstuffs uncoupled from the receiving container and where there is not any influence from the user, the coupling means is always situated in the second position. Consequently, as a result, the tensioning means ensures that with the device for the comminution of foodstuffs in an uncoupled state, it is not capable of causing the drive unit to be activated, as a result of which there is no risk of injury to the user.

In a preferred realization, the device for the comminution of foodstuffs can be coupled, in particular directly, with the receiving container on a first side and with the drive unit on a second side, which is in particular located opposite the first side. The coupling of the receiving container with the macerator can be effected as a result of a positive-locking and/or frictional-locking connection. In particular, the coupling can be realized by a threaded connection, the receiving container comprising an external thread on its couplable portion facing the macerator and a projection which protrudes from a container wall. The external thread of the receiving container can be coupled with an internal thread of the macerator, it being possible for the internal thread be provided on the inside surface of the macerator wall of the macerator.

The device for the comminution of foodstuffs can comprise a cutting unit. The cutting unit can comprise a drive shaft which is connected, in particular directly, to at least one cutting means and is couplable with the drive unit at the end remote from the cutting means. The coupling of the device for the comminution of foodstuffs, in particular of the drive shaft, with the drive unit can be effected by means of a positive-locking and/or frictional-locking connection. In particular, the coupling can be effected by means of a jaw coupling. The cutting means can be housed in the macerator recess. As a result, a simple coupling of the device for the comminution of foodstuffs with the receiving container and/or the drive unit is possible.

In a preferred realization, when the receiving container is coupled with the device for the comminution of foodstuffs, the receiving container can transfer the coupling means into the first position. In particular, the coupling means can be transferred into the first position when the receiving container is inserted into the macerator, in particular into the gap of the macerator, and/or is screw-connected to the macerator. To this end, the projection which protrudes from the container wall of the receiving container can move into contact with the first coupling portion of the coupling element and displace the coupling means. Apart from the receiving container, no other device by means of which the coupling means can be transferred into the first position is consequently necessary, as a result of which it is simple to utilize the entire apparatus for the comminution of foodstuffs.

The drive unit can comprise a receiving means for receiving the device for the comminution of foodstuffs. It can be inserted into the receiving means independently of the position of the coupling means. So that this is also possible in the case of a device for the comminution of foodstuffs with coupling means that are situated in the first position, the switching element which is provided in the drive unit, in particular in a receiving container wall of the drive unit, can be arranged offset by a predefined spacing from an end face of the drive unit facing the device for the comminution of foodstuffs. As a result, providing a receiving means in the drive unit makes additional storage space for the device for the comminution of foodstuffs unnecessary as it can be placed in the receiving means.

The drive unit can be realized in such a manner that automatically activating said drive unit independently of the position of the coupling means is not possible. This applies both to the case where the device for the comminution of foodstuffs is coupled with the drive unit and also to the case where it is not coupled with the drive unit. This means that even in the case where the coupling element is situated in the first position or the drive triggering position and the device for the comminution of foodstuffs is coupled with the drive unit, the drive unit cannot be activated without a further action by the user, such as, for example, the above-mentioned exertion of force onto the receiving container and/or onto the device for the comminution of foodstuffs.

In a preferred realization, the receiving container can comprise a container opening which can be closed by the device for the comminution of foodstuffs. The container opening serves for inserting the foodstuffs into the receiving container. The receiving container can comprise just one single opening, namely the container opening, Consequently, with the receiving container coupled with the device for the comminution of foodstuffs and/or the device for the comminution of foodstuffs coupled with the drive unit, a side of the receiving container comprising the container opening can rest, in particular directly, on the macerator, in particular on the macerator bottom.

As a result, the device for the comminution of foodstuffs acts as a bottom of the receiving container when the device for the comminution of foodstuffs rests on the drive unit and is consequently coupled with said drive unit. As a result of realizing the device for the comminution of foodstuffs in the previously named manner, with regard to realizations where the device for the comminution of foodstuffs extends through a receiving container bottom, the number of components of the device for the comminution of foodstuffs is reduced as no separate cover is necessary for closing the container opening.

The drive unit can comprise at least one movable switching element which is in contact with the coupling means exclusively when the coupling means is situated in the first position. This consequently ensures that the drive unit can only be activated when the coupling means is in the first position.

When the device for the comminution of foodstuffs and/or the receiving container which is coupled with the device for the comminution of foodstuffs is moved along the respective center axis, in particular in the direction to the drive unit, the switching element can be switched over from an Off position into an On position in which the drive unit drives the cutting unit. This ensures that the user has to be positively active in order to activate the drive unit and in order to be able to comminute the foodstuffs which are situated in the receiving container.

The switching element can be coupled with a tensioning means which moves, in particular automatically, the switching element from the On position into the Off position. Said movement can be effected once the user does not exert any force onto the device for the comminution of foodstuffs and/or onto the receiving container. It is consequently ensured that the switching element moves automatically, and consequently without user intervention, into the Off position.

The tensioning element can be realized in such a manner that the switching element cannot move from the Off position into the On position on account of the weight force of the device for the comminution of foodstuffs and/or of the receiving container. In order to realize said switching over, as already mentioned above, the user has to exert a force onto the receiving container and/or onto the device for the comminution of foodstuffs.

The drive unit can comprise a fixing means, in particular a bayonet connection. As a result of said fixing means, the device for the comminution of foodstuffs can be fixed in a releasable manner in the drive unit when the switching element is in the On position. To this end, once a user has exerted a force onto the receiving container and/or onto the device for the comminution of foodstuffs in order to move the switching element into the On position, the receiving container and/or the device for the comminution of foodstuffs can be rotated about the center axis. The achievement here is that the tensioning means acting upon the switching element is not able to move the switching element back into the Off position. As a result, it can be achieved that the foodstuffs are comminuted without the user having to exert a further force onto the receiving container and/or onto the device for the comminution of foodstuffs.

According to a further aspect of the invention, a set is produced from a plurality of devices for the comminution of foodstuffs and from a plurality of receiving containers. In this case, each receiving container has associated therewith at least one device for the comminution of foodstuffs and/or an outside diameter of a portion of the receiving container which is couplable with the device for the comminution of foodstuffs is equal to an inside diameter of a macerator gap of at least one of the plurality of devices for the comminution of foodstuffs.

The form of the individual receiving containers can differ from one another. The devices for the comminution of foodstuffs can also differ from one another by the form of the cutting means in addition to the inside diameter of the macerator gap.

### BRIEF DESCRIPTION OF THE DRAWING VIEWS

The object of the invention is shown schematically in the drawing and is described below by way of the figures, identical or identically operating elements being provided in the majority of cases with the same references, in which:

FIG. 1 shows a perspective view of an apparatus for the comminution of foodstuffs according to a first realization,

FIG. 2 shows an oblique top view in perspective of the device for the comminution of foodstuffs according to a first realization,

FIG. 3 shows an oblique bottom view in perspective of the device for the comminution of foodstuffs according to a first realization,

FIG. 4 shows an exploded representation of the receiving container and of the device for the comminution of foodstuffs according to a first realization,

FIG. 5 shows the device for the comminution of foodstuffs and the receiving container according to a first realization in the coupled state,

FIG. 6 shows a sectioned view along the longitudinal axis of the device for the comminution of foodstuffs and of the receiving container according to a first realization in an uncoupled state,

FIG. 7 shows a sectioned view along the longitudinal axis of the device for the comminution of foodstuffs and of the receiving container according to a first realization in the coupled state,

FIG. 8 shows a perspective view of the apparatus for the comminution of foodstuffs according to a first realization, in which a part region has been cut out,

FIG. 9 shows a side view of the apparatus for the comminution of foodstuffs, in which a part region has been cut out,

FIG. 10 shows a perspective view of an apparatus for the comminution of foodstuffs according to a second realization,

FIG. 11 shows an oblique top view in perspective of the device for the comminution of foodstuffs according to a second realization,

FIG. 12 shows an oblique bottom view in perspective of the device for the comminution of foodstuffs according to a second realization,

FIG. 13 shows an exploded representation of the receiving container and of the device for the comminution of foodstuffs according to a second realization,

FIG. 14 shows the device for the comminution of foodstuffs and the receiving container according to a second realization in the coupled state,

FIG. 15 shows a sectioned view along the longitudinal axis of the device for the comminution of foodstuffs and of the receiving container according to a second realization in an exploded representation,

FIG. 16 shows a sectioned view along the longitudinal axis of the device for the comminution of foodstuffs and of the receiving container according to a second realization in the coupled state,

FIG. 17 shows a perspective view of the apparatus for the comminution of foodstuffs according to a second realization, in which a part region has been cut out,

FIG. 18 shows a side view of the apparatus for the comminution of foodstuffs, in which a part region has been cut out.

### DETAILED DESCRIPTION OF THE INVENTION

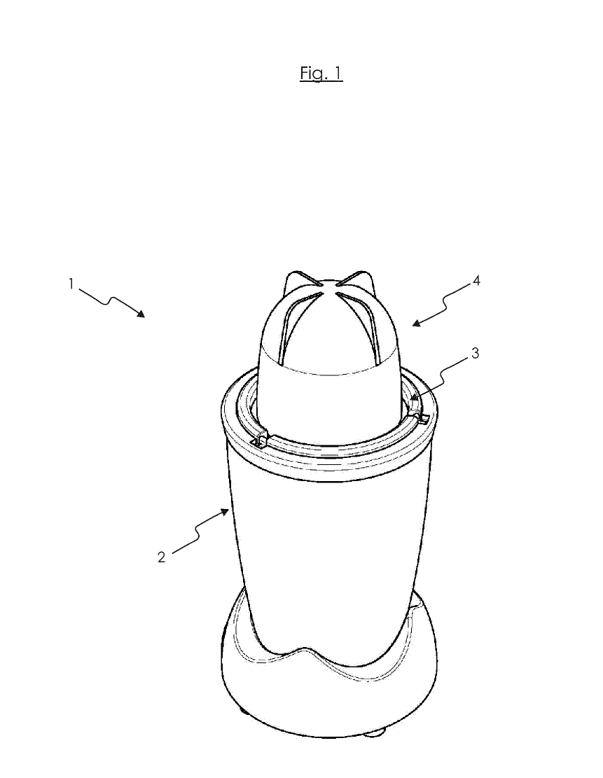

The apparatus 1 for the comminution of foodstuffs shown in FIG. 1 comprises a receiving container 4 for receiving foodstuffs, a drive unit 2 and a device 3 for the comminution of the foodstuffs for comminuting the foodstuffs that are situated in the receiving container 4. The device 3 for the comminution of foodstuffs 3 is coupled both with the receiving container 4 and with the drive unit 2. In particular, the device 3 for the comminution of foodstuffs is arranged in a receiving means of the drive unit 2.

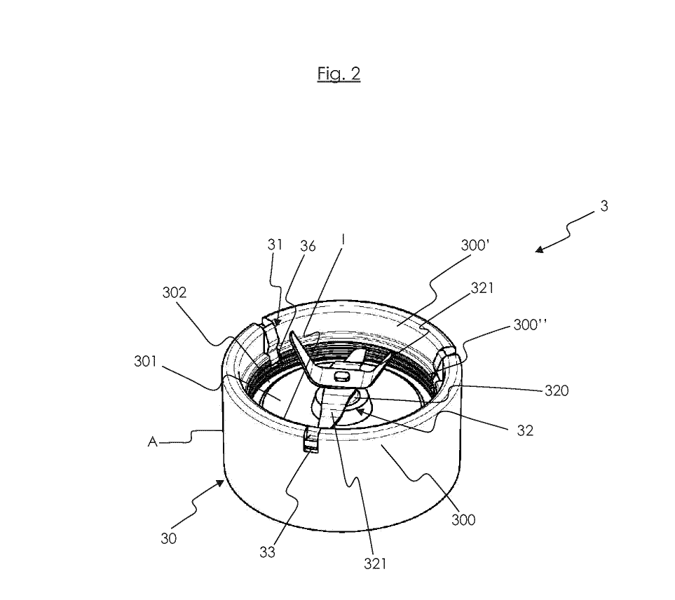

The device 3 for the comminution of foodstuffs is shown in FIG. 2 and comprises a macerator 30, several coupling elements 31 and a cutting unit 32. The cutting unit 32 comprises a drive shaft 320 and two cutting elements 321 which are coupled with the drive shaft 320. The coupling elements 31 are mounted on the macerator so as to be rotatable, the coupling elements 31 being arranged at a spacing from one another in the circumferential direction of the macerator 30.

On its side facing the receiving container 4, the macerator 30 is realized in a cup-shaped manner. It comprises a macerator wall 300. The macerator wall 300 surrounds a macerator gap, the macerator gap being defined by a macerator bottom. The macerator bottom is realized in two stages, a first bottom portion 301 being surrounded by a second ring-shaped bottom portion 302. When the receiving container 4 is coupled with the device 3 for the comminution of foodstuffs, an end face, in particular an end face surrounding a container opening, of the receiving container 4 moves into contact with the second bottom portion 302.

The first bottom portion 301 extends from the second bottom portion 302 in the direction of the cutting element 321. In particular, the first bottom portion 301 extends from the second bottom portion 302 in such a manner that it penetrates into the container opening of the receiving container 4 when the receiving container 4 is coupled with the device 3 for the comminution of foodstuffs.

The part of the macerator wall 300 which defines the macerator gap is realized in two stages. A first wall stage 300′ is arranged further away from the macerator bottom than a second wall stage 300″ and comprises a larger inside diameter than the second wall stage 300″. The macerator wall 300 comprises openings 33 which extend from an inside surface I of the macerator wall 300 to an outside surface A of the macerator wall 300. The coupling means 3 can move in the associated opening 33 in order to assume the various positions. The openings 33 are provided in the first wall stage 300′.

Over and above this, the macerator wall 300 comprises recesses 36 into which the coupling means 3 also extend in part and in which the coupling means 3 are rotatably mounted. The recesses 36 are provided on an inside surface I of the macerator wall 300, in particular of the second wall portion 300″, and do not extend fully through the macerator wall 300. In addition, the recesses 36 are connected to the respectively associated openings 33. The macerator wall 300, in particular the second wall portion 300′, additionally comprises on the inside surface I an internal thread, by means of which the device 3 for the comminution of foodstuffs is able to be coupled with the receiving container 4.

The drive shaft 320 of the cutting unit 32 extends in part through the macerator 30 and is arranged coaxially with respect to said macerator. In this case, the drive shaft 2 is connected to the cutting elements 321 at the end projecting into the macerator gap.

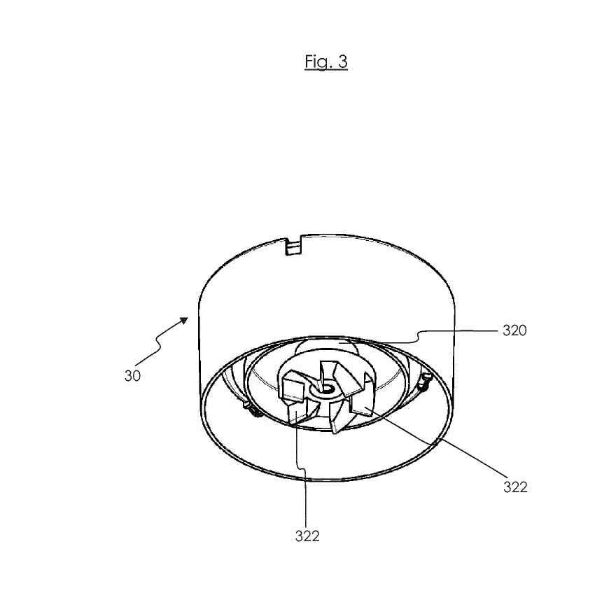

As can be seen from FIG. 3, the drive shaft 320 is connected to jaws 322 of a jaw coupling at its end remote from the cutting element 321. Counter jaws, not shown in the figures, are provided on the drive unit 4. The jaws 322 of the device 3 for the comminution of foodstuffs move into operative connection with the counter jaws of the drive unit 4 when the device 3 for the comminution of foodstuffs is arranged in the receiving means of the drive unit 4. This means that when the drive unit 4 is activated, a rotational movement of the drive unit 4 is transmitted to the cutting elements 321 by means of the jaw coupling and the drive shaft 320.

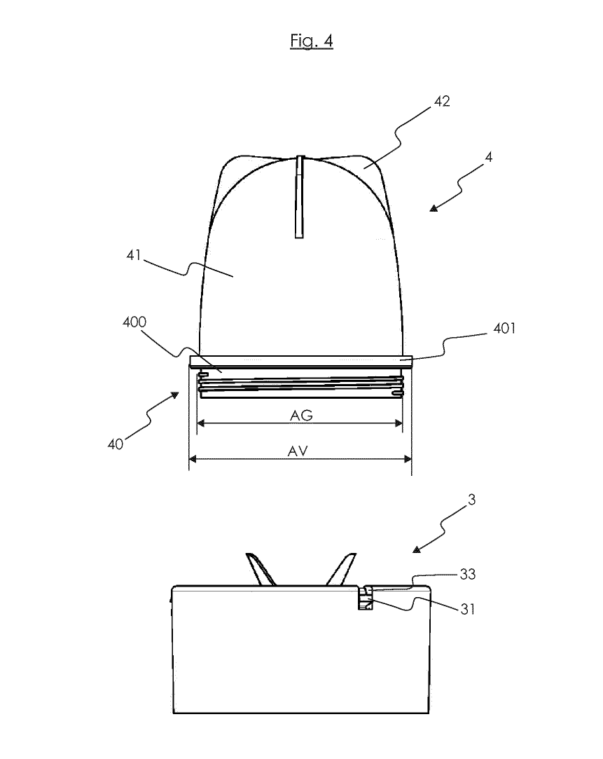

FIG. 4 shows an exploded representation of the receiving container 4 and of the device 3 for the comminution of foodstuffs. On its end facing the device 3 for the comminution of foodstuffs, the receiving container 4 comprises a portion 40 which is couplable with the device 3 for the comminution of foodstuffs. The couplable portion 40 comprises an external thread 400 and a projection 401. The, in particular ring-shaped, projection 401 protrudes from a container wall 41 of the receiving container 4, in particular in the radial direction.

An outside diameter AV of the projection 401 is greater than the outside diameter AG of the external thread 400. The outside diameter AV of the projection 401 corresponds to or corresponds substantially to the inside diameter of the first wall portion 300′ of the macerator 30, ensuring, however, that the receiving container is able to be inserted into the macerator gap. The outside diameter AG of the external thread 400 corresponds to or corresponds substantially to the inside diameter of the second wall portion 300″. Feet 42 are provided at the end of the receiving container 4 remote from the device 3 for the comminution of foodstuffs. The feet 42 make it possible for the receiving container 4 to be able to be placed on a flat surface without it falling over.

With the receiving container 4 and the device 3 for the comminution of foodstuffs in the uncoupled state as shown in FIG. 4, the coupling means 31 are situated in the second position which is designated below as a safety position. In the safety position, the coupling means 31 do not protrude or only protrude slightly from the outside surface of the macerator wall 30.

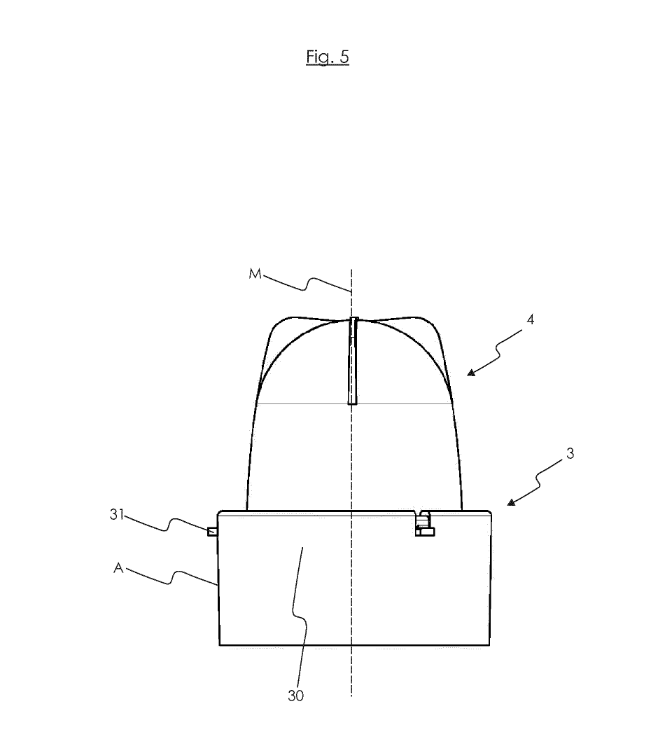

FIG. 5 shows the receiving container 4 and the device 3 for the comminution of foodstuffs in a coupled position. In said position, the coupling means 31 are situated in a first position which is designated below as a drive triggering position. In the drive triggering position, the coupling elements 31 stand out from the outside surface A of the macerator wall 30 in the radial direction.

The receiving container 4 can be screw-connected to the device 3 for the comminution of foodstuffs by means of the external thread 40 and the internal thread that is present on the second wall portion 300″. Consequently, a movement of the receiving container 4 relative to the device 3 for the comminution of foodstuffs along a center axis M of the device 3 for the comminution of foodstuffs is prevented.

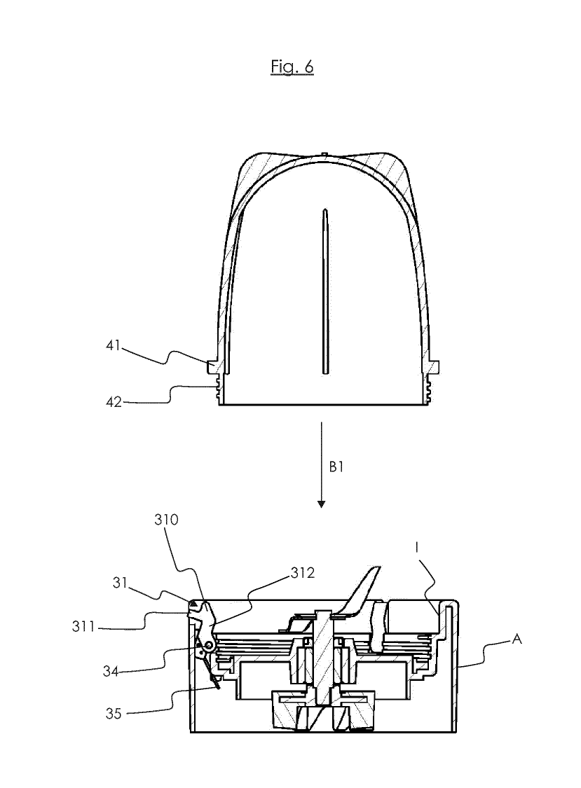

As can be seen from FIG. 6, the coupling means 31 is mounted on the macerator 30 so as to be rotatable by means of a joint 34. In addition, the coupling means 31 is connected to a tensioning means 35 which is supported on the macerator 30 at the end remote from the coupling means 31. The tensioning means 35 is realized and arranged in such a manner that when the coupling means 31 moves into the drive triggering position, the tensioning means 35 is tensioned.

With the receiving container 4 and the device 3 for the comminution of foodstuffs in the uncoupled state, the coupling means 31 stands out from the inside surface I of the macerator wall 30, in particular from the inside surface I of the first wall portion 300′, radially inward. The coupling means 31 comprises a first coupling portion 310 which is realized in an oblique manner with reference to the center axis M of the device 3 for the comminution of foodstuffs and/or to an insertion direction B of the receiving container 4.

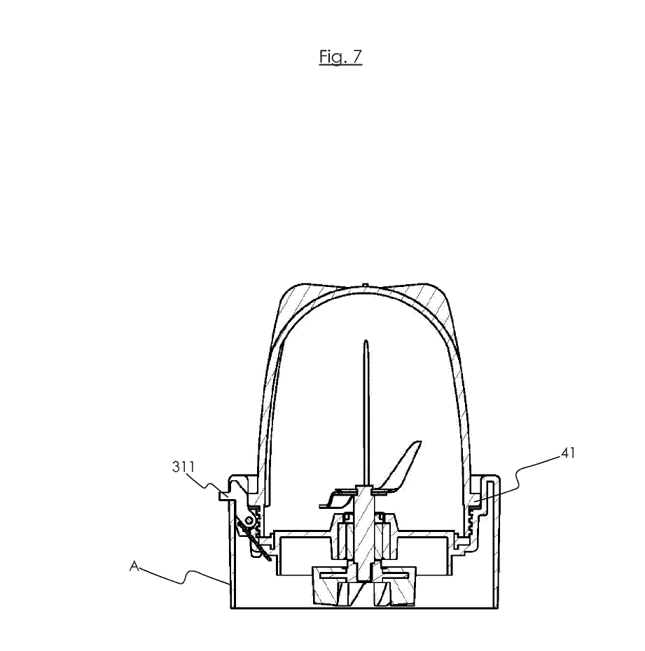

In addition, the coupling means 31 comprises a second coupling portion 311 which extends, in particular in the radial direction, from the first coupling portion 310 and with the coupling means 31 in the safety position is arranged substantially fully in the opening 33. As can be seen from FIG. 7, the second coupling portion 312 protrudes in part from the outside surface A of the macerator 30 when the coupling means 31 is situated in the drive triggering position.

In addition, the coupling means 31 comprises a third coupling portion 312 which is connected to the first and second coupling portions 310, 311. The third coupling portion 312 is realized in such a manner that it is in direct contact with an end face of the projection 41 of the receiving container 4 with the coupling means in the drive triggering position. In addition, the form of the third coupling portion 312 is realized in a complementary manner to that of the projection 41, in particular to that of a radial end face of the projection 41, as shown in FIG. 7. In contrast, the first coupling portion 310 is realized in such a manner that it is not in contact with the projection 41 in the drive triggering position and extends obliquely with respect to the center axis M of the device 3 for the comminution of foodstuffs.

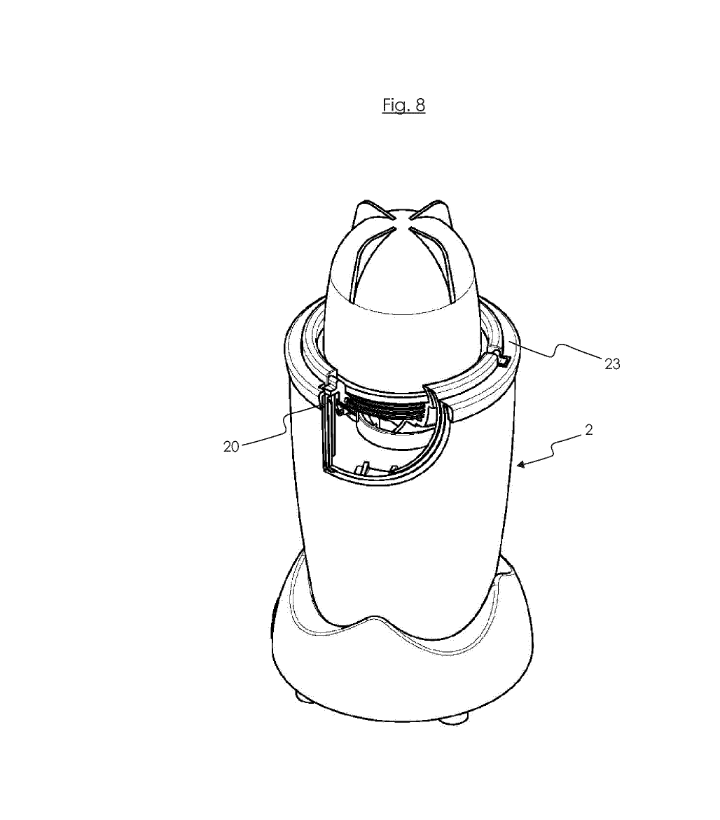

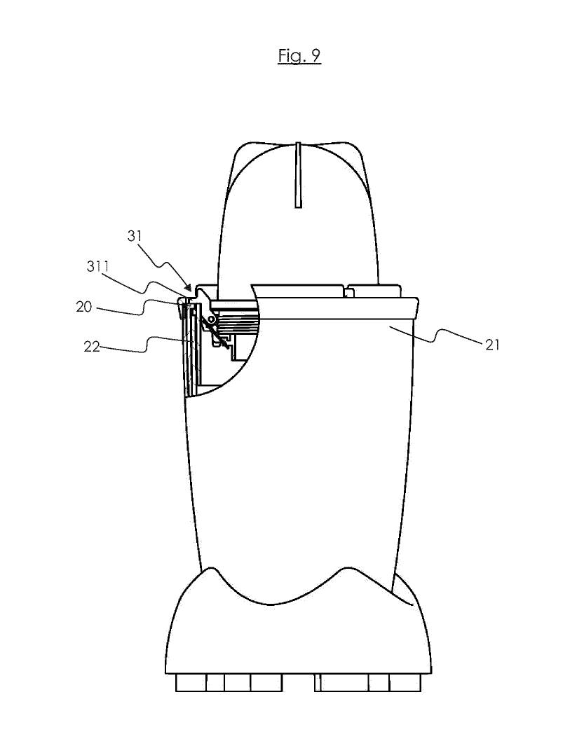

The drive unit 4, as can be seen from FIGS. 8 and 9, comprises a receiving means into which the device 3 for the comminution of foodstuffs is inserted in order to produce a coupling between the device 3 for the comminution of foodstuffs and the drive unit 2. Over and above this, the drive unit 2 comprises several switching elements 20 which are arranged spaced apart from one another in the circumferential direction.

The switching elements 20 are arranged in a gap of the receiving container wall 21 and are situated in an Off position in which the drive unit 2 is not activated. The switching element 20 is lowered along the center axis of the drive unit 4 with reference to an end face 23 of the receiving container 3 facing the device 3 for the comminution of foodstuffs. The gap in the receiving container wall 21 and the switching element 20 are realized in such a manner that the switching element 20 is able to be moved by a certain spacing in a direction parallel to a center axis of the drive unit 4 and relative to the receiving container wall 21 before it strikes against an inner region 22 of the receiving container wall. After the movement or after it strikes against the inner region 22, the switching element 20 is situated in an On position in which the drive unit 4 is activated and in which a torque is transferred from the drive unit 4 via the jaw coupling to the cutting unit of the device 3 for the comminution of foodstuffs.

The device 3 for the comminution of foodstuffs which is coupled with the receiving container 4 is placed in such a manner onto the drive unit 2 that the coupling means 31, in particular the second coupling portion 311, rests on the switching element 20. The switching element 20 is coupled at the end remote from the coupling means 31 with a further tensioning means (not shown) which pre-stresses the switching element 20 in the Off position. The further tensioning means is realized in such a manner that the switching element 20 does not move into the On position on account of the weight force of the receiving container 4 and of the device 3 for the comminution of foodstuffs.

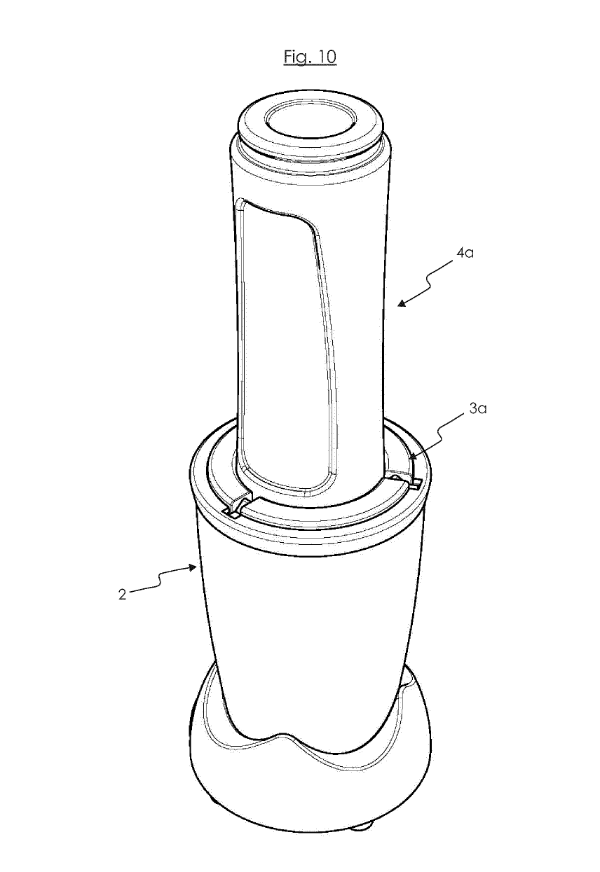

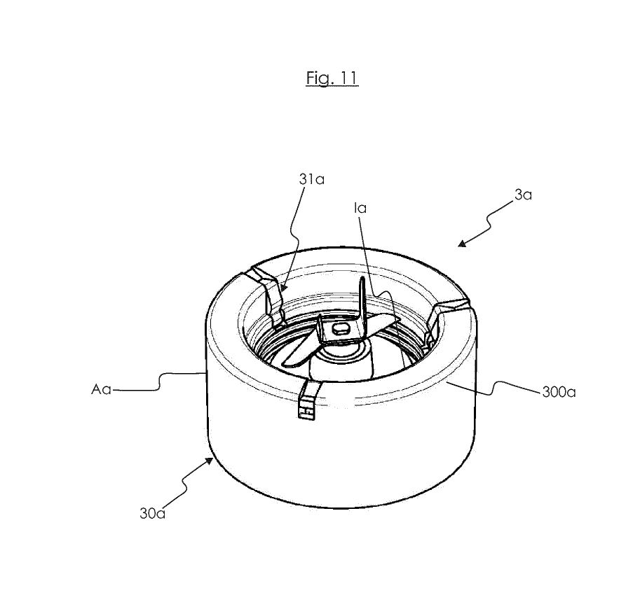

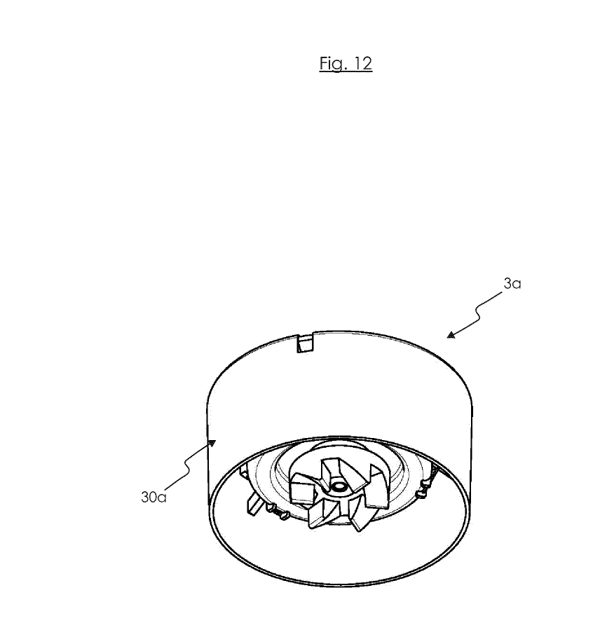

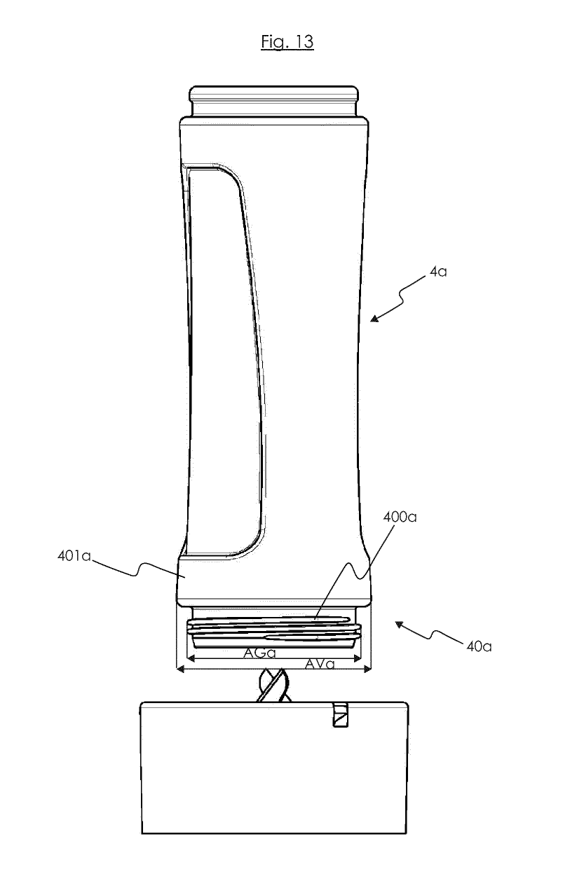

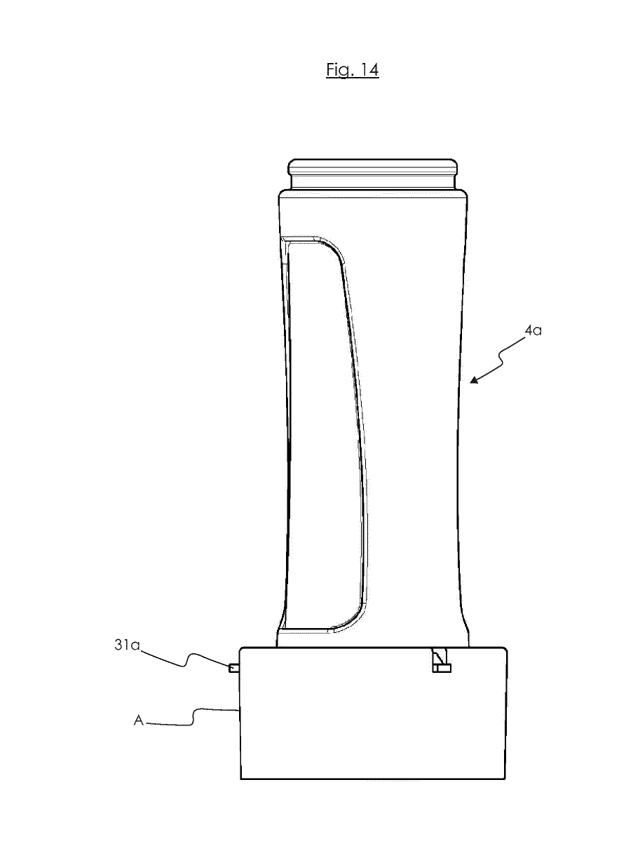

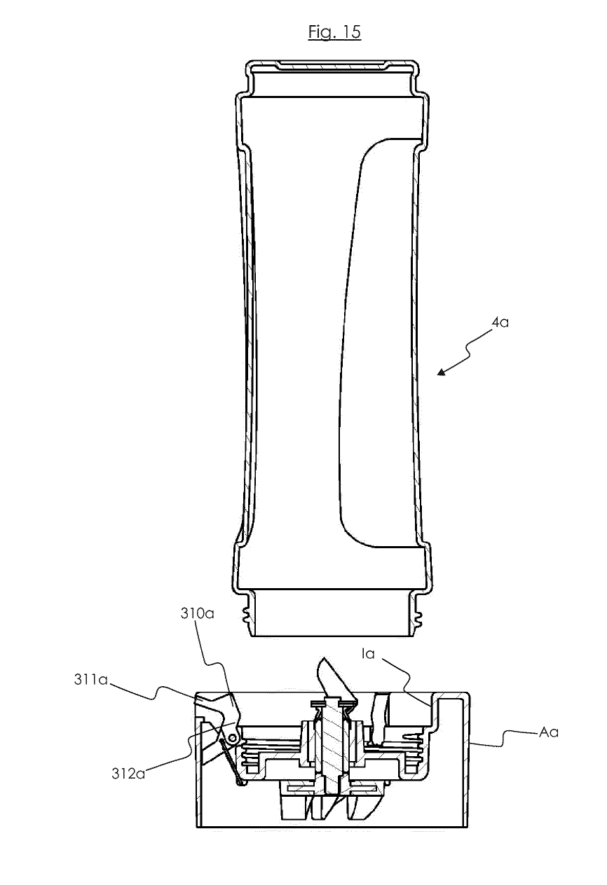

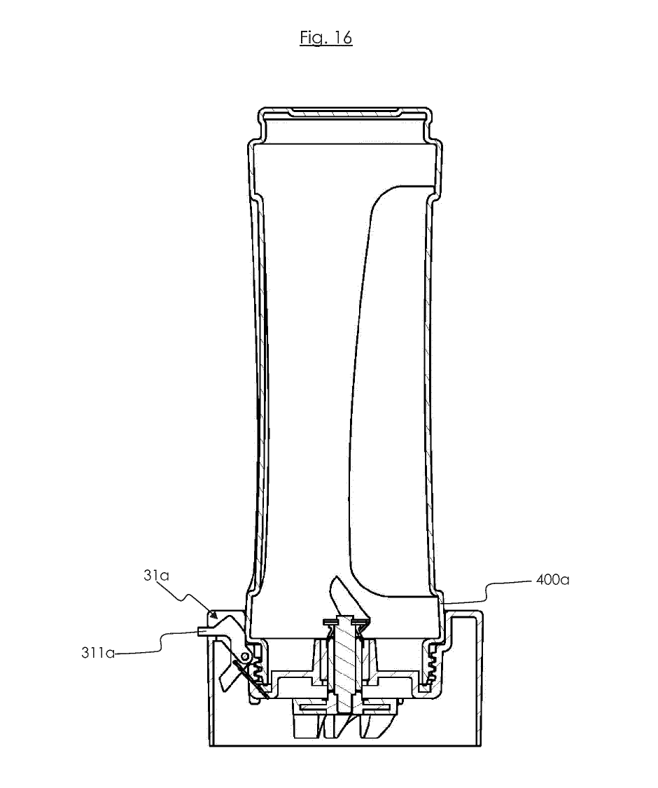

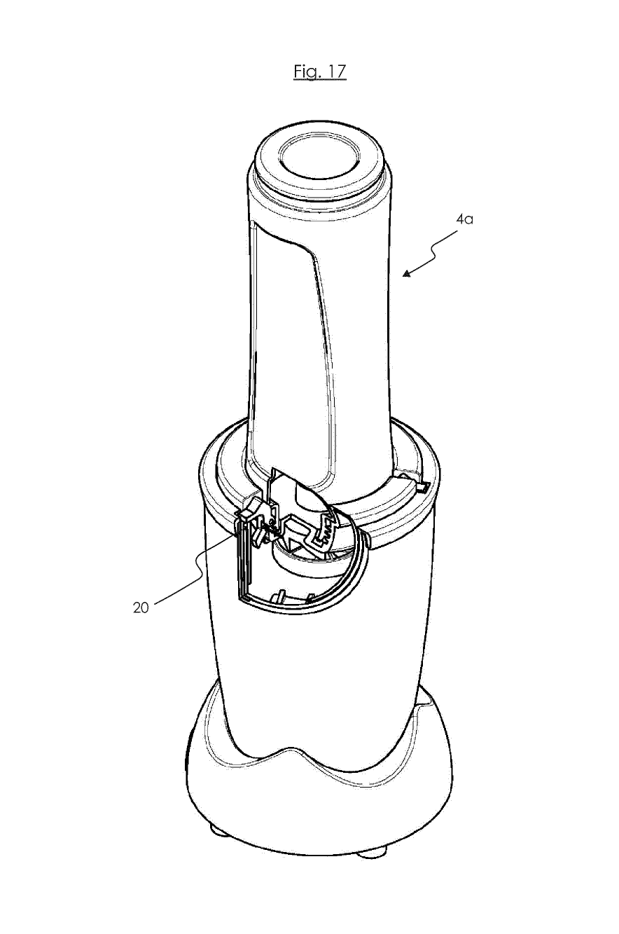

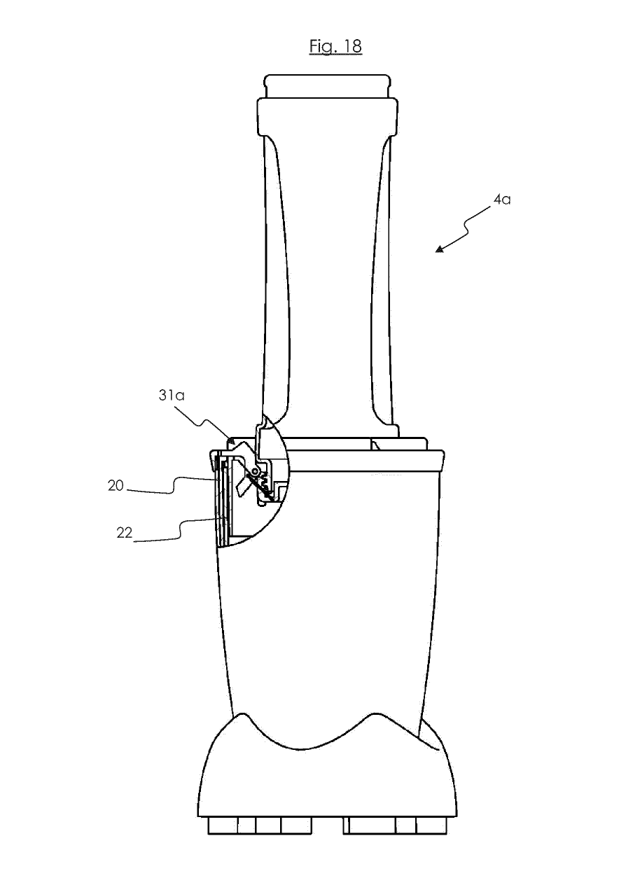

FIGS. 10 to 18 show, among other things, a device for the comminution of foodstuffs and a receiving container according to a second realization. Only the differences between the two realizations are expanded upon below.

The outer form of the receiving container 4a according to the second realization differs from that of the receiving container 4 according to the first realization. Thus, the receiving container 4a is realized in a clearly narrower and more elongated manner than the receiving container 4 according to the first realization. On account of the narrower realization of the receiving container 4a, the projection 401a and/or the external thread 400a of the couplable portion 40a comprises a smaller outside diameter (AVa, AGa) than the projection 401 and/or the external thread 400 of the receiving container 4 according to the first realization.

The device 3a for the comminution of foodstuffs according to the second realization differs from the device 3 for the comminution of foodstuffs according to the first realization in the realization of the macerator 30a and of the coupling means 31a. Thus, the macerator wall 300a, in particular the first and/or second wall portion 300′, 300″, of the macerator 30a comprises a smaller inside diameter than the macerator wall 300 of the macerator 30 according to the first realization.

On account of the smaller inside diameter of the macerator wall 300a, the radial spacing between the inside surface Ia and the outside surface Aa of the macerator 30a is greater than in the first realization. Consequently, the form of the coupling means 3a, in particular of the three coupling portions 310a, 311a, 312a, is modified in such a manner that said coupling means is able to stand out from the outside surface Aa of the macerator 30a in the drive triggering position. In particular, the second coupling portion 312a is realized in a more elongated manner than the second coupling portion 312 according to the first realization.

The operation of an apparatus for the comminution of foodstuffs according to the first realization is described below, the operation of the apparatus for the comminution of foodstuffs according to the second realization or to another realization with another form of the receiving container being effected in the same manner.

After filling the foodstuffs to be comminuted into the receiving container 4, said receiving container is closed by means of the device 3 for the comminution of foodstuffs and consequently coupled with said device. For coupling, the receiving container 4 is inserted into the macerator gap of the macerator 30 with its end comprising the couplable portion 40 in front or the device 3 for the comminution of foodstuffs is placed onto said receiving container. When inserting, the projection 40 moves into direct contact with the first coupling portion 310 and presses it outward in the radial direction such that the second coupling portion 311 stands out from the outside surface A of the macerator wall 30a.

To couple the receiving container 4 further with the device 3 for the comminution of foodstuffs, the receiving container 4 is rotated about its own longitudinal axis such that the receiving container 4 and the device 3 for the comminution of foodstuffs are screw-connected together by means of the external thread and the internal thread of the macerator. As a result, once the receiving container 4 has been coupled with the device 3 for the comminution of foodstuffs, the coupling means 31 are situated in the drive triggering position.

The device 3 for the comminution of foodstuffs is placed onto the drive unit 2 or inserted into the receiving means of the drive unit 2 in such a manner that the coupling means 31 rest directly on the respectively associated switching element 20 of the drive unit 2.

A force is then exerted by the user onto the receiving container 4 and/or onto the device 3 for the comminution of foodstuffs in the direction of the drive unit 2. The force is directed parallel or substantially parallel to the center axis of the receiving container 4 and/or the device 3 for the comminution of foodstuffs. Due to the exertion of force, the coupling elements 31 press the switching elements 20 in a direction away from the receiving container 4 and move the switching elements 20 into the On position. In the On position, the drive unit 2 is activated and a torque output by the drive unit 2 is transferred to the cutting unit 32 of the device 3 for the comminution of foodstuffs, as a result of which the foodstuffs situated in the receiving container 4 are comminuted.

As soon as the user stops exerting force on the receiving container and/or on the device for the comminution of foodstuffs, the switching means 20 is pressed into the Off position by the further tensioning means, as a result of which the drive unit is deactivated.

### LIST OF REFERENCES

1 Apparatus for the comminution of foodstuffs
2 Drive unit
3, 3a Device for the comminution of foodstuffs
4, 4a Receiving container
20 Switching element
21 Receiving container wall
22 Inside region
23 End face of the drive unit
30, 30a Macerator
31, 31a Coupling means
32 Cutting unit
33 Opening
34 Joint
35 Tensioning element
36 Recess
40, 40a Couplable portion
41 Container wall
300 Macerator wall
300′ First wall stage
300″ Second wall stage
301 First bottom portion
302 Second bottom portion
310, 310a First coupling portion
311, 311a Second coupling portion
312, 312a Third coupling portion
320 Drive shaft
321 Cutting element
322 Jaw
400, 400a External thread
401, 401a Projection
A, Aa Outside surface
B Insertion direction
I, Ia Inside surface
M Center axis
AV, AVa Outside diameter of the projection
AG, AGa Outside diameter of the external thread

1. A device (3) for the comminution of foodstuffs, the device being usable in an apparatus (1) having a drive unit (2) and a receiving container (4), wherein the device (3) comprises:
a cutting unit;
a macerator (30) couplable with the drive unit (2) and with the receiving container (4); and
at least one movable coupling means (31) mounted on the macerator (30), wherein when the receiving container (4) is coupled with the macerator (30) the coupling means (31) is situated in a first position and when the receiving container (4) is uncoupled from the macerator (30) the coupling means (31) is situated in a second position;
wherein the first position of the coupling means (31) corresponds to a drive triggering position wherein driving the cutting unit (32) by means of the drive unit (2) is possible.

2. The device (3) for the comminution of foodstuffs as claimed in claim 1, wherein
the second position of the coupling means (31) corresponds to a safety position wherein driving the cutting unit (32) by means of the drive unit (2) is not possible.

3. The device (3) for the comminution of foodstuffs as claimed in claim 1, wherein
a. the coupling means (31) is mounted on the macerator (30) so as to be rotatable and/or
b. the coupling means (31) stands out radially inward from an inside surface (I) of the macerator (30), in particular radially inward, in the second position and/or
c. the coupling means (31) comprises a first coupling portion (310) which can be brought into contact, in particular direct contact, with the receiving container (4) when coupling the receiving container (4) with the macerator (30) and/or
d. the coupling means (31) stands out from an outside surface (A) of the macerator (30), in particular radially outward, in the first position.

4. The device (3) for the comminution of foodstuffs as claimed in claim 1, wherein the device (3) for the comminution of foodstuffs is couplable with the receiving container (4) on a first side and with the drive unit (2) on a second side, which is in particular located opposite the first side.

5. The device (3) for the comminution of foodstuffs as claimed in claim 1, wherein a tensioning element (35) is connected to the coupling means (31) and brings about a return movement of the coupling means (31) from the first position into the second position once the receiving container (4) has been uncoupled from the macerator (30).

6. The device (3) for the comminution of foodstuffs as claimed in claim 1, wherein the cutting unit (32) comprises a drive shaft (320) and at least one cutting means (321) which is connected, in particular directly, to the drive shaft (320), wherein the drive shaft (320) is couplable with the drive unit (2) at an end remote from the cutting means (321).

7. A system having a device (3) for the comminution of foodstuffs (3) as claimed in claim 1 and having
a. a receiving container (4) which is couplable with the device (3) for the comminution of foodstuffs and/or
b. a drive unit (2) which is couplable with the device (3) for the comminution of foodstuffs.

8. The system as claimed in claim 7, wherein when the receiving container (4) is coupled with the device (3) for the comminution of foodstuffs, the receiving container (4) transfers the coupling means (31) into the first position.

9. The system as claimed in claim 7, characterized in that
a. the drive unit (2) comprises a receiving means for the device (3) for the comminution of foodstuffs, wherein the device (3) for the comminution of foodstuffs is insertable, in particular directly, into the receiving means irrespective of the position of the coupling means and/or
b driving the drive unit (2) automatically irrespective of the position of the coupling means (31) is unfeasible.

10. The system as claimed in claim 7, wherein the device (3) for the comminution of foodstuffs closes a container opening of the receiving container (4).

11. The system as claimed in claim 7, wherein the drive unit (2) comprises at least one movable switching element (20) which is in contact with the coupling means (31) exclusively when said coupling means is situated in the first position.

12. The system as claimed in claim 11, wherein when the device (3) for the comminution of foodstuffs moves along a center axis (M) thereof, in particular in the direction to the drive unit (2), the switching element (20) switches over from an Off position into an On position in which the drive unit (2) drives the cutting unit (32).

13. The system as claimed in claim 12, wherein the switching element (20) is coupled with a tensioning means which moves, in particular automatically, the switching element (20) from the On position into the Off position.

14. The system as claimed in claim 12, wherein the drive unit (2) comprises a fixing means, in particular a bayonet connection, for releasably fixing the device (3) for the comminution of foodstuffs in the drive unit (2) when the switching element (20) is in the On position.

15. A set comprising a plurality of devices (3) for the comminution of foodstuffs as claimed in claim 1 and from a plurality of receiving containers (4), wherein
a. each receiving container (4) has associated therewith at least one device (3) for the comminution of foodstuffs and/or
b. an outside diameter (AV, AG) of a portion (40) of the receiving container (4), which is couplable with the device (3) for the comminution of foodstuffs, is equal to an inside diameter of a macerator gap of at least one of the plurality of devices (3) for the comminution of foodstuffs.
